(19) United States
(12) Patent Application Publication
(10) Pub. No.: US 2011/0232064 A1
(43) Pub. Date: Sep. 29, 2011

(54) Apparatus For Indicating a Wish Has Been Made and Method Of Using Same

(76) Inventor: Conor Boyd, Queensbury, NY (US)

(21) Appl. No.: 13/071,148

(22) Filed: Mar. 24, 2011

Related U.S. Application Data
(60) Provisional application No. 61/317,362, filed on Mar. 25, 2010.

(51) Int. Cl. B23P 19/00; B32B 3/02; B32B 15/00; B32B 1/00; A44C 5/02

(52) U.S. Cl. 29/426.5; 428/80; 428/594; 428/28; 428/34.1; 63/4

(57) ABSTRACT

An assembly for symbolically indicating a person's desire or wish will be granted, and methods of using the assembly. A symbolic device in the shape of a wishbone, limited to having only first and second bodies. Each of the first and second bodies have first and second ends. The first ends of the first and second bodies are releasably coupled at a union of the first ends of the first and second bodies. The symbolic device is open between the second ends of the first and second bodies when the first ends of the first and second bodies are releasably coupled at the union of the first ends of the first and second bodies. The method for symbolically indicating a person's desire or wish will be granted comprises providing the assembly and separating the releasably coupled first ends of the first and second bodies of the symbolic device.

The present patent application is a non-provisional application claiming priority from provisional application Ser. No. 61/317,362 (filed Mar. 25, 2010 and titled “Apparatus and Method For Symbolically Indicating A Desire Or Wish Will Be Granted”).

### FIELD OF THE INVENTION

The present invention relates generally to symbolic devices and methods of using the devices. More specifically, the present invention relates to devices for symbolically indicating a person's desire will be granted, e.g. for symbolically indicating a wish will be granted, and methods of using the devices.

### BACKGROUND

Symbolic devices have been used historically to express beliefs and desires. Sometimes the symbolic devices have been known for hundreds of years and are found in folklore. For example, many people believe that the four leaf clover symbolizes good luck to the person who discovers it. People who share this belief often choose to wear the symbolic device, e.g., as jewelry.

There is a need in the industry for symbolic devices that are related to people's beliefs and desires.

### SUMMARY OF THE INVENTION

A first aspect of the present invention provides an assembly for symbolically indicating a person's desire or wish will be granted, comprising: a symbolic device in the shape of a wishbone, limited to having only first and second bodies, wherein each of the first and second bodies have first and second heads, first and second angles, and first and second distal ends, wherein the first heads of the first and second bodies are releasably coupled at a union of the first heads of the first and second bodies, and wherein the symbolic device is open between the first and second distal ends of the first and second bodies when the first and second heads of the first and second bodies are releasably coupled at the union of the first and second heads of the first and second bodies, or wherein the symbolic device is a closed annulus when the first and second heads of the first and second bodies are releasably coupled at the union of the first and second heads of the first and second bodies.

A second aspect of the present invention provides a method for symbolically indicating a person's desire or wish will be granted, comprising: providing a symbolic device in the shape of a wishbone, wherein the symbolic device comprises first and second bodies, and wherein each first and second body comprises first and second heads, first and second arms, and first and second angles, therebetween; and separating the releasably coupled first and second heads to Indicate the making of the wish.

A third aspect of the present invention provides a kit for symbolically indicating a person's desire or wish will be granted, comprising: a chain; and a symbolic device in the shape of a wishbone, limited to having only first and second bodies, wherein each of the first and second bodies have first and second ends, wherein the first ends of the first and second bodies are releasably coupled at a union of the first ends of the first and second bodies, and wherein the symbolic device is open between the second ends of the first and second bodies when the first ends of the first and second bodies are releasably coupled at the union of the first ends of the first and second bodies.

A fourth aspect of the present invention provides an assembly for symbolically indicating a person's desire or wish will be granted, consisting essentially of: a symbolic device in the shape of a wishbone, limited to having only first and second bodies, wherein each of the first and second bodies have first and second heads, first and second angles, and first and second distal ends, wherein the first heads of the first and second bodies are releasably coupled at a union of the first heads of the first and second bodies, and wherein the symbolic device is open between the first and second distal ends of the first and second bodies when the first and second heads of the first and second bodies are releasably coupled at the union of the first and second heads of the first and second bodies, or wherein the symbolic device is a closed annulus when the first and second heads of the first and second bodies are releasably coupled at the union of the first and second heads of the first and second bodies.

### BRIEF DESCRIPTION OF THE FIGURES

The features of the invention are set forth in the appended claims. The invention itself, however, will be best understood by reference to the following detailed description of an illustrative embodiment when read in conjunction with the accompanying drawings, wherein:

FIG. 1A depicts a plan view of an assembly for symbolically indicating a person's desire or wish will be granted, having a post and socket alignment guides, in accordance with embodiments of the present invention;

FIG. 1B depicts an exploded plan view of the alignment guide(s). depicted in FIG. 1A, in accordance with embodiments of the present invention;

FIG. 2 depicts a plan view of the assembly for symbolically indicating a person's desire or wish will be granted, having a bridge and tunnel operable coupling, in accordance with embodiments of the present invention;

FIG. 3 depicts a top plan view of the assembly for symbolically indicating a person's desire or wish will be granted, having a protruding and embedded permanent magnet releasable coupling and alignment guides, in accordance with embodiments of the present invention;

FIG. 4 depicts a plan view of the assembly depicted in FIG. 2, wherein the bridge and tunnel operable coupling has been replaced with a molded loop coupling, in accordance with embodiments of the present invention;

FIG. 5 depicts a top plan view of an assembly for symbolically indicating a person's desire or wish will be granted, having a chain threaded through an operable coupling, in accordance with embodiments of the present invention;

FIG. 6 depicts a top plan view of an alternative embodiment of an assembly for symbolically indicating a person's desire or wish will be granted, in which the operable coupling is coupled to proximal ends of the first and second bodies, in accordance with embodiments of the present invention;

FIG. 7 depicts of an alternative embodiment of an assembly for symbolically indicating a person's desire or wish will be granted, in which an opening of the symbolic device may become a closed annulus, in accordance with embodiments of the present invention;

FIG. 8 depicts a top plan view of the assembly depicted in FIG. 6, in which the operable coupling is coupled to distal ends of the first and second bodies, in accordance with embodiments of the present invention; and

FIG. 9 is a schematic flow diagram depicting a method for symbolically indicating a person's desire or wish will be granted, in accordance with embodiments of the present invention.

### DETAILED DESCRIPTION OF EMBODIMENTS OF THE INVENTION

The invention meets a need in the art by providing methods and symbolic devices for symbolically indicating a person's desire will be granted, e.g. for symbolically indicating a wish will be granted, and methods of using the devices.

Many people believe that breaking a wishbone is a step in a process that foretells whether a wish made, will be granted. According to this belief, the wish of a person holding the larger arm of the wishbone will be granted. Alternatively, two wishes will be granted, according to the belief, if the wishbone breaks into equal lengths.

Jewelry based on wishbone shapes is very popular, even with those who don't share the belief, and is an important aspect of the jewelry industry.

The symbolic devices of the present invention may have the shape of a wishbone. The wishbone, known in anatomy as the furcula, is a fused clavicle bone found in birds that is shaped like the letter “Y”. The symbolic devices of the present invention having first and second bodies also may be oriented in a wishbone shape represented by the letter “Y”. In this embodiment, the first and second bodies have a plane of symmetry that runs along the union between the first and second bodies, and the first and second bodies may be releasably coupled.

People who believe that breaking a wishbone is a step in a process that foretells whether a wish made, will be granted, will be able to substitute the symbolic devices of the present invention, instead of authentic wishbones derived from birds. In addition, the symbolic devices of the present invention may be advantageously reusable and free from filth, infection, or dangers to health. Use of the symbolic devices of the present invention is more economical in terms of cost, availability, as well as being more humane compared to use of the authentic wishbones derived from birds.

In addition, the symbolic devices of the present invention may be advantageously used as jewelry, or charms compared to the authentic wishbone derived from birds because they are capable of being more attractive and customizable to a particular taste or fashion.

### I. DEFINITIONS

As used herein, unless otherwise defined, the singular forms “a”, “an”, and “the” include plural references unless the context clearly dictates otherwise. Thus, for example, reference to “a post or socket” includes a plurality of such posts and sockets, and so forth.

As used herein, unless otherwise defined, the term “reiterate” or “reiteratively” means to repeat: to say, state, or perform again.

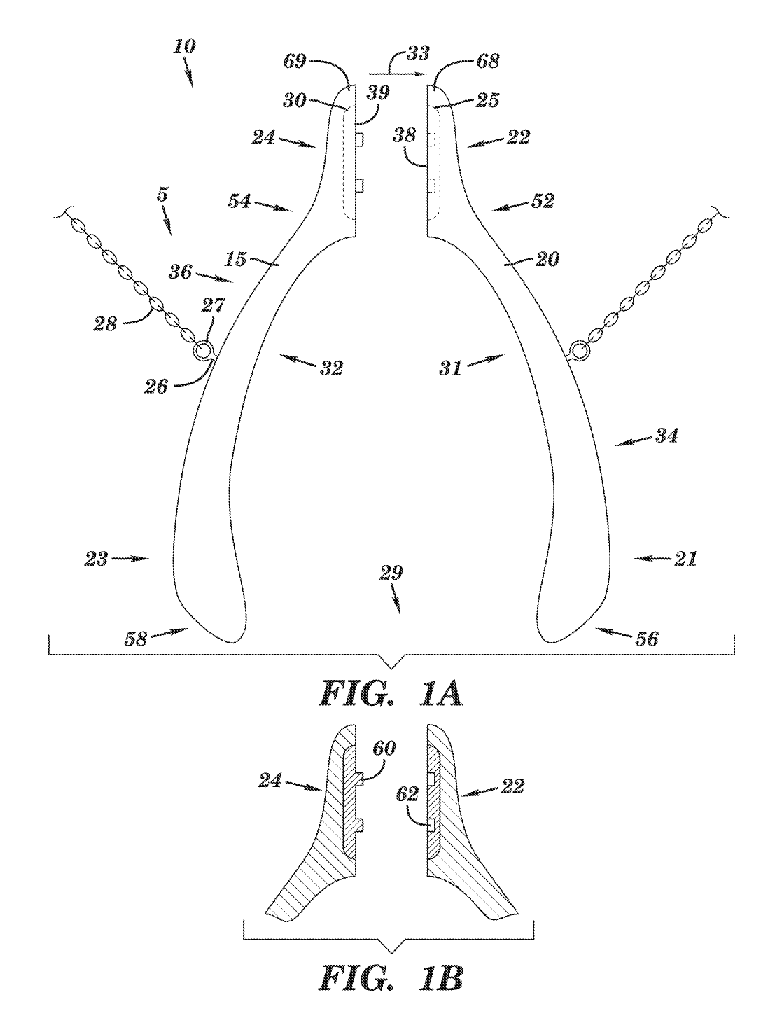

As used herein, unless otherwise defined, the term “releasably coupling” or “releasably coupled” or “releasably joined” is defined as forming or braking or cleaving or severing of a mechanical coupling between the union 50 of the first heads 24, 22 of the first and second bodies 23, 21, depicted in FIGS. 1A, 2-6 and described in associated text, herein.

As used herein, unless otherwise defined, the term “desire” is defined as a person's longing, or strong inclination for a specific thing that can be granted or fulfilled by anyone, including the person.

As used herein, unless otherwise defined, the term “wish” is defined as a desire that may only be granted or fulfilled by another.

As used herein, unless otherwise defined, the phrase, “[A]pparatus or method for symbolically indicating a person's desire or wish will be granted” means using the symbolic device of the present invention, instead of an authentic wishbone derived from a bird, to symbolically indicate a person's desire or wish will be granted.

As used herein, unless otherwise defined, the terms ‘distal end” and “proximal end” refer to opposite ends of the first or second arm 15, 20, having first and second heads 24, 22, wherein the proximal ends 69, 68 are closest to the first and second heads 24, 22 and the distal ends 58, 56 are farthest from the first and second heads 24, 22.

As used herein, unless otherwise defined, the terms ‘distal end” and “proximal end” refer to opposite ends of the first or second bodies 23, 21, having first and second heads 24, 22, wherein the proximal ends 69, 68 are closest to the first and second heads 24, 22 and the distal ends 58, 56 are farthest from the first and second heads 24, 22.

As used herein, unless otherwise defined, the term “nubs and depressions” is defined as a bump or a cavity, respectively, on either respective opposing lateral inner surface 39, 38 of the first and second heads 24, 22.

As used herein, unless otherwise defined, the term “posts and sockets”” is defined as any appropriate compression fitting comprising a compressible male end that fits into a female end, and forms a seal or union between the male and female ends when the male end expands. An example of a post and socket compression fitting is the ball and socket compression fitting, in which the male ball compresses to fit into the female socket and then expands to form a releasably coupled seal or union.

As used herein, unless otherwise defined, the term “unitary construction” is defined as being one piece.

As used herein, unless otherwise defined, the term “torsional force” is defined as a type of force that twists the first and second bodies 23, 21 so the first and second heads of the 24, 22, can be decoupled, thereby deforming the union 50.

FIG. 1A depicts a plan view of a symbolic assembly 10 for symbolically indicating a person's desire or wish will be granted, in accordance with embodiments of the present invention. The symbolic assembly 10 comprises: a symbolic device 5, limited to having only first and second bodies 23, 21, respectively. Therefore, each first and second body 23, 21, has unitary construction.

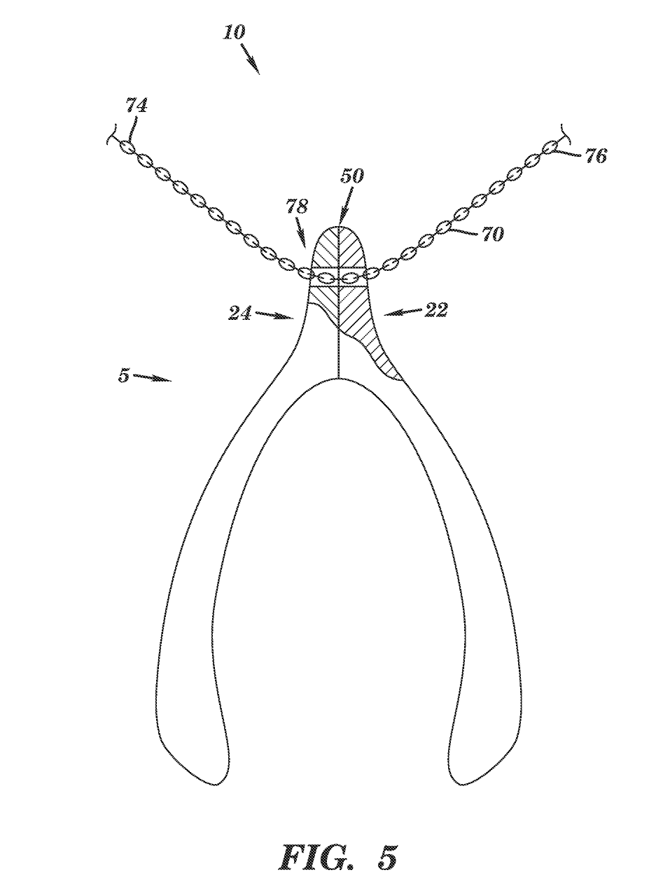

In one embodiment, the symbolic device 5 may have the shape of a wishbone. The wishbone, known in anatomy as the furcula, is a fused clavicle bone found in birds that is shaped like the letter “Y”. The first and second bodies 23, 21 also may be oriented in a wishbone shape represented by the letter “Y”. In this embodiment, the first and second bodies 23, 21 have a plane of symmetry that runs along union 50 between the first and second bodies 23, 21, when the first and second bodies 23, 21 are releasably coupled, as depicted in FIGS. 5-7.

The first and second bodies 23, 21, each being of unitary construction, comprise first and second heads 24, 22, first and second arms 15, 20, and first and second angles 54, 52, therebetween, respectively. In one embodiment, the first and second bodies 23, 21 taper or narrow in diameter at the first and second angles 54, 52 of the first and second bodies 23, 21, or the portion of the first and second bodies 23, 21 lying between the first and second arms 15, 20, and the first and second heads 24, 22.

The first and second heads 24, 22 of the first and second bodies 23, 21 are releasably coupled at a union 50 of the first heads 24, 22 of the first and second bodies 23, 21, depicted in FIGS. 1A, 1B, 2-4, and 8, and described in associated text, herein. The union 50 may be formed by releasably coupling first head 24 of first body 23 with first head 22 of second body 21.

In one embodiment, the symbolic device 5 consists essentially of only two pieces, e.g. the first and second bodies 23, 21, wherein the releasably coupled first and second heads 24, 22 may be decoupled by moving each of the first and second heads 24, 22 in antiparallel directions, i.e., parallel but oppositely directed directions, wherein one of the first and second heads 24, 22 is moved in the direction shown by the arrow 33.

In one embodiment, the first and second heads 24, 22 of the first and second bodies 23, 21 may be releasably coupled by the attractive forces of permanent magnets 30, 25 inset in an inner surface 39, 38 of the first and second heads 24, 22 of the first and second bodies 23, 21. The permanent magnets 30, 25 are inset in the inner surface 39, 38 of the first and second heads 24, 22 so that the inner surfaces 39, 38 may be even and smooth, because the permanent magnets 30, 25 do not interrupt the even, smooth inner surfaces 39, 38.

FIG. 1B depicts an exploded plan view of the alignment guide(s) 60, 62, in which the alignment guide(s) 60, 62 are nubs and depressions, respectively.

Referring to FIGS. 1A, 1B, the term “releasably coupling” and “releasably coupled” is defined as forming a union, e.g., union 50, by mechanically joining the first and second heads 24, 22 of the first and second bodies 23, 21, e.g., by moving the first head 24 of the first body 23 in a direction of the arrow 33, so that it becomes releasably coupled or releasably joined to the first head 22 of the first body 23.

In one embodiment, decoupling the releasably coupled first and second heads 24, 22 of the first and second bodies 23, 21 may result in a snapping or breaking sound when torsional forces or forces that move the heads 24, 22 in antiparallel directions are applied against the force of attraction of the magnets, releasing the first and second heads 24, 22.

In like manner, decoupling the releasably coupled first and second heads 24, 22 of the first and second bodies 23, 21 may result in a snapping or breaking sound when torsional forces or forces that move the heads 24, 22 in antiparallel directions are applied to decouple the alignment guide(s) 60, 62, releasing the first and second heads 24, 22.

FIG. 1A depicts the symbolic device 5 may have an opening 29 between the first and second distal ends 58, 56 of the first and second bodies 23, 21 when the first heads 24, 22 of the first and second bodies 23, 21 are releasably coupled at the union 50 of the first and second heads 24, 22 of the first and second bodies 23, 21. Releasably coupling and decoupling the first and second heads 24, 22 at the union 50 enables the symbolic assembly 10 to be reusable for symbolically indicating a person's desire or wish will be granted.

The operable coupling 26 is selected from the group consisting of an eye hook, a molded loop, a bridge/tunnel clasp, and combinations thereof. The term “operable coupling” is defined as forming a union, e.g., union 27, by mechanically joining the first and second ends 64, 66 of the chain 28, e.g., by linking the last link of the chain 28 with the operable coupling 26, so that the last link of the chain 28 and the operable coupling become mechanically joined.

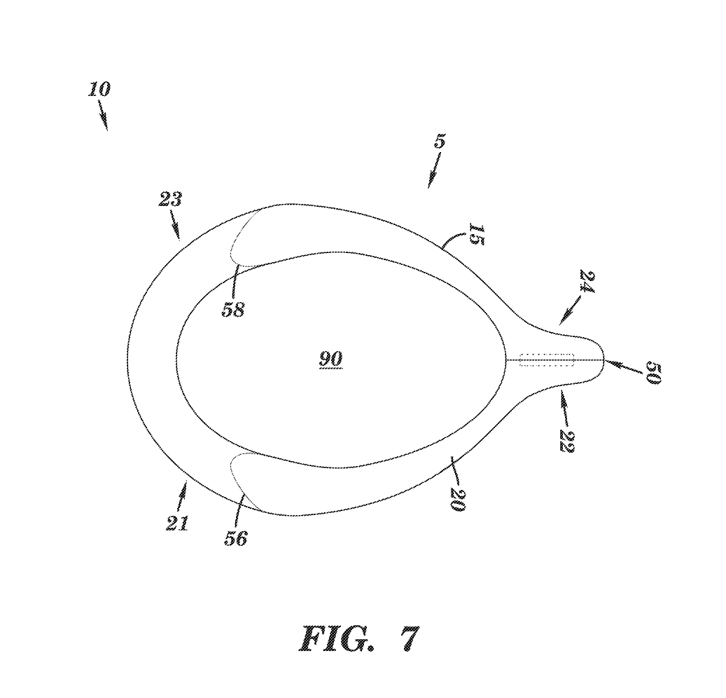

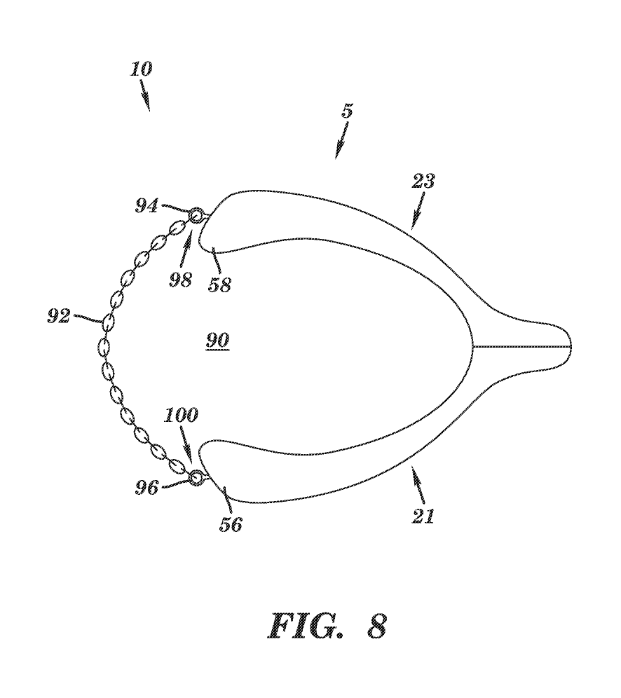

FIGS. 7-8 depict an alternative embodiment in which the opening 29 of the symbolic device 5 may become a closed annulus 90 when the first heads 24, 22 of the first and second bodies 23, 21 are releasably coupled at the union 50 of the first heads 24, 22 of the first and second bodies 23, 21, and the first and second distal ends 58, 56 come together so the first and second distal ends 58, 56 become coextensive. In this embodiment, the symbolic device 5 may be a bracelet, or a necklace.

In one embodiment, a lateral inner surface 32, 31 of each first and second arm(s) 15, 20, between the angles 54, 52 and the distal ends 58, 56 advantageously has a concave shape, and the corresponding lateral outer surface 36, 34 of each first and second arm(s) 15, 20, between the angles 54, 52 and the distal ends 58, 56 advantageously has a convex shape.

In one embodiment, the lateral inner surface 32, 31 of each first and second arm(s) 15, 20, between the angles 54, 52 and the distal ends 58, 56 and the corresponding lateral outer surface 36, 34 of each first and second arm(s) 15, 20, between the angles 54, 52 and the distal ends 58, 56 advantageously gradually flatten and the flat surfaces of the arms 15, 20 are turned inwardly.

Referring to FIG. 1A, in one embodiment, opposing inner lateral surface(s) 39, 38 of the first and second heads 24, 22 comprise permanent magnets 30, 25 oriented so that they have a magnetic attraction.

In one embodiment, one opposing lateral inner surface 39, 38 of the first and second heads 24, 22 comprises a magnetizable material and the other opposing inner surface 39, 38 of the first and second heads 24, 22 comprises a permanent magnet 30, 25.

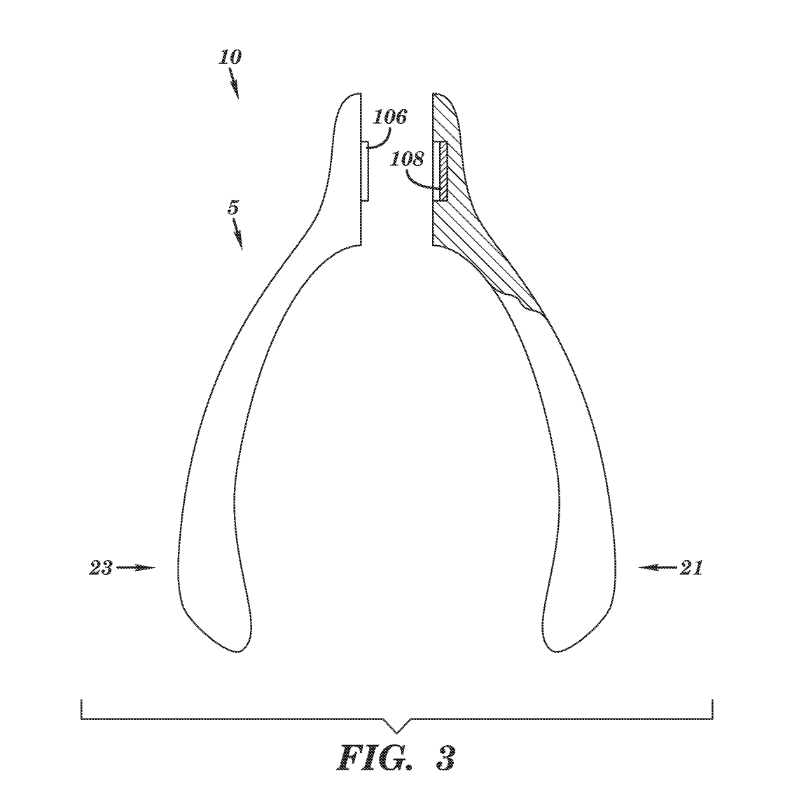

FIG. 3 depicts an embodiment in which one of the permanent magnets 106, 108 may be embedded in the first head 24, 22 of the first and second bodies 23, 21 so it may be recessed in the first head 24, 22 of the first and second bodies 23, 21, and the other permanent magnet 106, 108 protrudes from the respective opposing lateral inner surface 39, 38 of the first head 24, 22 of the other first and second bodies 23, 21.

In one embodiment, depicted by FIG. 3, the magnetizable material may protrude from the respective opposing lateral inner surface 39, 38 of the first and second heads 24, 22 and the permanent magnet 106, 108 may be embedded in the first head 24, 22 of one first and second body 23, 21 and recessed in the first head 24, 22 of the other first and second body 23, 21, and vice versa. In one embodiment, depicted by FIG. 1A, the permanent magnets 30, 25 may be embedded in and flush with each respective opposing lateral inner surface 39, 38 of the first and second heads 24, 22.

In one embodiment, the permanent magnet 30, 25 and the magnetizable material may be embedded in and flush with each respective opposing lateral inner surface 39, 38 of the first and second heads 24, 22.

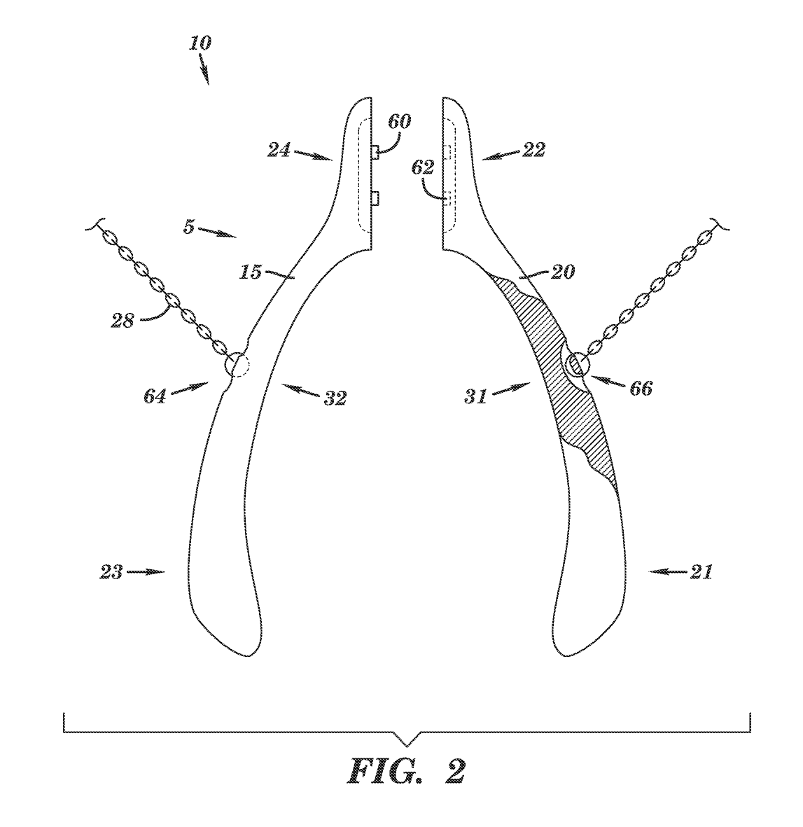

FIGS. 2-3 depict a plan view of the symbolic assembly 10, in accordance with embodiments of the present invention. In FIGS. 2-3, opposing lateral inner surfaces 39, 38 of the first heads 24, 22 of each arm 15, 20 may be releasably coupled utilizing at least one alignment guide(s) 60, 62, 106, 108.

FIGS. 1B, 2 depict an embodiment in which the alignment guide(s) 60, 62, may be nubs and depressions, respectively. Alternatively, alignment guide(s) 60, 62, may be posts and sockets.

In one embodiment, the post and socket may be a compression fitting, e.g., ball and socket. In one embodiment, a compressible ring may circumscribe the post so that the ring may expand after the ball is fitted into the socket.

FIG. 3 depicts an embodiment in which the alignment guide(s) 106, 108 may be permanent magnets or a permanent magnet and magnetizable material, respectively.

In one embodiment, depicted in FIG. 1A, one opposing inner surface 39, 38 includes a socket 62 adapted for receiving at least one alignment guide(s) 60, and vice versa.

In one embodiment, one opposing inner surface 39, 38 the socket 62 may be a depression adapted for receiving at least one alignment guide(s) 60, 62, e.g., a nub, therein. In one embodiment, the material of construction of the symbolic device 5 is selected from the group consisting of plastic, gold, stone, glass, pewter, silver, platinum, bone, and stainless steel.

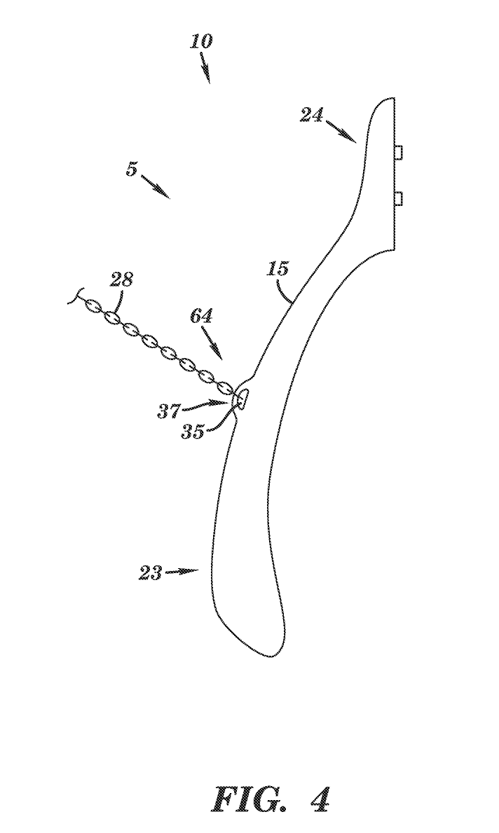

FIG. 4 depicts a side elevation view of the symbolic assembly 10, comprising a chain 28 having first and second ends 64, 66, wherein the first end 64 of the chain 28 is operably coupled to the first body 23 of the first arm 15 of the symbolic device 5 and the second end 66 of the chain 28 is operably coupled to the second body 21 of the of the second arm 20 of the symbolic device 5, as depicted in FIG. 2 and described herein. The chain 28, 70, 92 may be a ornamental chain, or a necklace, made of gold, e.g., 14 or 24 carat gold, platinum or silver links, gold or silver plated metals, alloys, or polished stainless steel.

FIG. 4 depicts the symbolic assembly 10, in accordance with embodiments of the present invention. FIG. 4 depicts an embodiment in which the operable coupling 35 is selected from the group consisting of an eye hook, a molded loop, a bridge/tunnel clasp, and combinations thereof. The term “operable coupling” is defined as forming a union, e.g., union 37, by mechanically joining the first and second ends 64, 66 of the chain 28, e.g., by linking the last link of the chain 28 with the operable coupling 35, so that the last link of the chain 28 and the operable coupling become mechanically joined.

FIG. 5 depicts a top plan view of the symbolic assembly 10, comprising: a chain 70 having first and second ends 74, 76. The first end 74 of the chain 70 has been threaded through the operable coupling 78 located in the first heads 24, 22 of the first and second bodies 23, 21 of the symbolic device 5 and operably coupled to the chain 70.

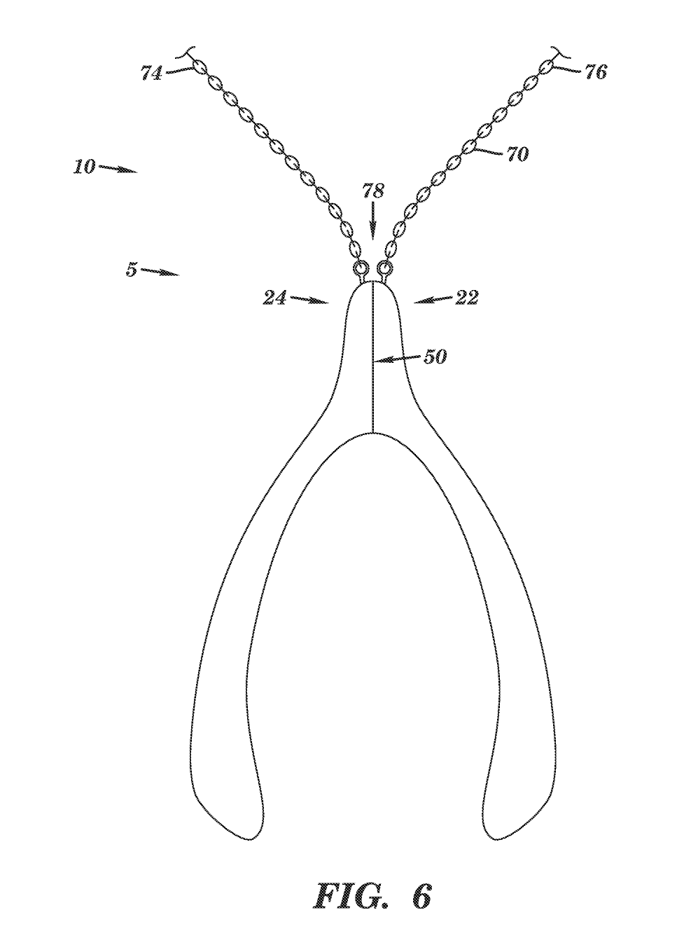

In one embodiment, FIG. 6 depicts the operable coupling 78 is selected from the group consisting of an eye hook, a transverse opening through the first ends of the first and second bodies 23, 21, a molded loop, a bridge/tunnel clasp, and combinations thereof.

FIG. 8 depicts a top plan view of the symbolic assembly 10, comprising: a chain 92 having first and second ends 94, 96, wherein the first and second ends 94, 96 of the chain 92 have been operably coupled to operable couplings 98, 100 located on the first and second distal ends 58, 56 of the first and second bodies 23, 21 of the symbolic device 5.

In one embodiment, the operable couplings include an eye hook, a molded loop, a transverse opening through the first ends of the first and second bodies 23, 21, or a bridge/tunnel clasp.

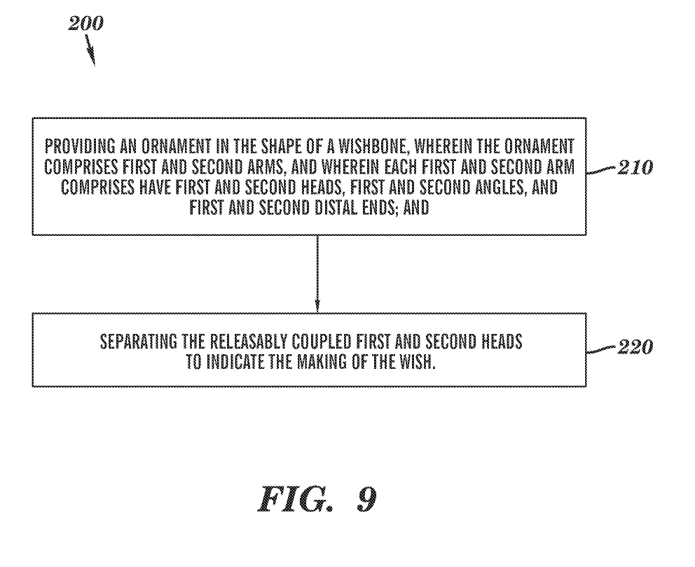

FIG. 9 is a schematic flow diagram depicting a method 200 for symbolically indicating a person's desire or wish will be granted. In a step 210 of the method 200, a symbolic device 5 is provided. The symbolic device 5 comprises first and second bodies 23, 21, in the shape of a wishbone. Each of the first and second bodies 23, 21 have first and second heads 24, 22, first and second angles 54, 52, and first and second distal ends 58, 56. The first and second heads 24, 22 are releasably coupled.

In a step 220 of the method 200, the releasably coupled first and second heads 24, 22 are separated to symbolically indicate a person's desire or wish will be granted.

In one embodiment of the step 210 of the method 200, the first and second heads 24, 22 of the first and second bodies 23, 21 are releasably coupled at a union 50 between permanent magnets 30, 25 embedded in the inner lateral surfaces 39, 38 of the first and second heads 24, 22 of the first and second bodies 23, 21.

In one embodiment, separating or decoupling alignment guides 60, 62, or permanent magnets 30, 25, or permanent magnet/magnetizable material 106, 108 of the releasably coupled first and second heads 24, 22 of the first and second bodies 23, 21 of the symbolic device 5 results in a snapping or popping sound associated with the breaking of a bird's wishbone.

In one embodiment, a clean break, essentially completely along union 50 results from separating or decoupling alignment guides 60, 62, or permanent magnets 30, 25, 106, 108 of the releasably coupled first and second heads 24, 22 of the first and second bodies 23, 21 of the symbolic device 5, so that the lateral inner surfaces 36, 34 of the first and second heads 24, 22 remain smooth and even, except where the alignment guides may protrude.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

I claim:

1. An assembly for symbolically indicating a person's desire or wish will be granted, comprising:
a symbolic device in the shape of a wishbone, limited to having only first and second bodies,
wherein each of the first and second bodies have first and second heads, first and second angles, and first and second distal ends,
wherein the first heads of the first and second bodies are releasably coupled at a union of the first and second heads of the first and second bodies, and
wherein the symbolic device is open between the first and second distal ends of the first and second bodies when the first and second heads of the first and second bodies are releasably coupled at the union of the first and second heads of the first and second bodies, or
wherein the symbolic device is a closed annulus when the first and second heads of the first and second bodies are releasably coupled at the union of the first and second heads of the first and second bodies.

2. The assembly of claim 1, wherein a lateral inner surface of each first and second arms between the angle and the distal end has a concave shape, and a lateral outer surface between the angle and the distal end has a convex shape.

3. The assembly of claim 1, wherein the arms of each body gradually flattens and the flat surfaces of the arms are turned inwardly.

4. The assembly of claim 1, wherein opposing inner surface(s) of the union comprise permanent magnets oriented so that they have a magnetic attraction.

5. The assembly of claim 4, wherein one opposing inner surface of the first and second heads comprises a magnetizable material and the other opposing inner surface of the first and second heads comprises a permanent magnet.

6. The assembly of claim 4, wherein one of the permanent magnets is embedded in the first end of one arm and is recessed in the first end of one arm, and the other permanent magnet protrudes from the respective opposing inner surface of the first end of the other arm

7. The assembly of claim 5, wherein the magnetizable material protrudes from the respective opposing inner surface of the first end of one arm and the permanent magnet is embedded in the first end of the other arm and recessed in the first end of the other arm, and vice versa.

8. The assembly of claim 4, wherein the permanent magnets are embedded in and flush with each respective opposing inner surface.

9. The assembly of claim 5, wherein the permanent magnet and the magnetizable material are embedded in and flush with each respective opposing inner surface.

10. The assembly of claim 4, wherein opposing inner surfaces of the first ends of each first and second body are releasably coupled utilizing at least one alignment guide(s) selected from the group consisting of nub and depression guide(s), and post and socket guide(s).

11. The assembly of claim 10, wherein one opposing inner surface includes a socket adapted for receiving the at least one alignment guide(s) therein.

12. The assembly of claim 10, wherein one opposing inner surface is a depression adapted for receiving the nub therein.

13. The assembly of claim 1, wherein the material of construction of the symbolic device is selected from the group consisting of plastic, gold, stone, glass, pewter, silver, bone, platinum, and stainless steel.

14. The assembly of claim 1, comprising: a chain having first and second ends, wherein the first end of the chain is operably coupled to the first arm of the first body of the symbolic device and the second end of the chain is operably coupled to the second arm of the of the second body of the symbolic device.

15. The assembly of claim 14, wherein the operable coupling is selected from the group consisting of an eye hook, a transverse opening through the first ends of the first and second bodies, a molded loop, a bridge/tunnel clasp, and combinations thereof.

16. The assembly of claim 1, comprising: a chain having first and second ends, wherein the first end of the chain has been threaded through an operable coupling located on the first ends of the first and second bodies of the symbolic device and operably coupled to the chain.

17. The assembly of claim 16, wherein the operable coupling is selected from the group consisting of an eye hook, a transverse opening through the first ends of the first and second bodies, a molded loop, a bridge/tunnel clasp, and combinations thereof.

18. The assembly of claim 17, wherein the chain is a bracelet or necklace.

19. The assembly of claim 1, comprising: a chain having first and second ends, wherein the first and second ends of the chain have been operably coupled to operable couplings located on the first and second distal ends of the first and second bodies of the symbolic device.

20. The assembly of claim 19, wherein the operable coupling is selected from the group consisting of an eye hook, a transverse opening through the first ends of the first and second bodies, a molded loop, a bridge/tunnel clasp, and combinations thereof.

21. The assembly of claim 20, wherein the chain is a bracelet or necklace.

22. A method for symbolically indicating a person's desire or wish will be granted, comprising:
providing a symbolic device in the shape of a wishbone,
wherein the symbolic device comprises first and second bodies, and
wherein each first and second body comprises first and second heads, first and second arms, and first and second angles, therebetween; and
separating the releasably coupled first and second heads to symbolically indicate a person's desire or wish will be granted.

23. The method of claim 22, wherein the first and second heads of the first and second bodies are releasably coupled at a union between permanent magnets embedded in the inner lateral surfaces of the first and second heads of the first and second bodies.

24. The method of claim 22, wherein separating alignment guides of the releasably coupled first and second heads of the first and second bodies of the symbolic device results in a snapping or popping sound associated with the breaking of a bird's wishbone.

25. A kit for symbolically indicating a person's desire or wish will be granted, comprising:
a chain; and
a symbolic device in the shape of a wishbone, limited to having only first and second bodies,
wherein each of the first and second bodies have first and second arms,
wherein first ends of the first and second bodies are releasably coupled at a union of the first ends of the first and second bodies, and wherein the symbolic device is open between the second ends of the first and second bodies when the first ends of the first and second bodies are releasably coupled at the union of the first ends of the first and second bodies, or wherein the symbolic device is a closed annulus when the first and second heads of the first and second bodies are releasably coupled at the union of the first and second heads of the first and second bodies.

26. The kit of claim 25, wherein the chain is a necklace or bracelet.

27. An assembly for symbolically indicating a person's desire or wish will be granted, consisting essentially of:
a symbolic device in the shape of a wishbone, limited to having only first and second bodies,
wherein each of the first and second bodies have first and second heads, first and second angles, and first and second distal ends,
wherein the first heads of the first and second bodies are releasably coupled at a union of the first heads of the first and second bodies, and
wherein the symbolic device is open between the first and second distal ends of the first and second bodies when the first and second heads of the first and second bodies are releasably coupled at the union of the first and second heads of the first and second bodies, or
wherein the symbolic device is a closed annulus when the first and second heads of the first and second bodies are releasably coupled at the union of the first and second heads of the first and second bodies.
